(19) United States
(12) Patent Application Publication
(10) Pub. No.: US 2009/0164285 A1
(43) Pub. Date: Jun. 25, 2009

(54) AUTO-CASCADING CLEAR TO BUILD ENGINE FOR MULTIPLE ENTERPRISE ORDER LEVEL PARTS MANAGEMENT

(75) Inventors: George M. Hurtis, Rochester, MN (US); Jason S. Lee, Oronoco, MN (US); Kay M. Momsen, Rochester, MN (US); Ryan T. Paske, Rochester, MN (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/961,594

(22) Filed: Dec. 20, 2007

(51) Int. Cl. G06Q 10/00

(52) U.S. Cl. 705/8

(57) ABSTRACT

Embodiments of the present invention provide a method, system and computer program product for an auto-cascading clear to build (CTB) tool for multiple enterprise parts management. A method for auto-cascading (CTB) for multiple enterprise parts management can include receiving a demand resulting in an inventory requirement to satisfy the demand, soft allocating inventory meeting a portion of the inventory requirement from multiple different intra-plant locations in an order of priority specified by a set of inventory location priority rules, further soft allocating inventory meeting a remaining portion of the inventory requirement from inventory of multiple different external suppliers in an order of priority specified by the set of inventory location priority rules, and hard reserving the soft allocated inventory and updating inventory levels both in each of the intra-plant locations and also in the external suppliers.

### REFERENCE TO CO-PENDING APPLICATIONS FOR PATENT

The present application is related to the following co-assigned U.S. Patent Applications, which are expressly incorporated by reference herein:

U.S. application Ser. No. ______, entitled “AUTO-CASCADING CLEAR TO BUILD ENGINE FOR MULTIPLE LOCATION ORDER LEVEL PARTS MANAGEMENT” (docket no. RPS920070061US1 (084U)), filed on Dec. ______, 2007.

### BACKGROUND OF THE INVENTION

1. Field of the Invention

The present invention relates to supply chain management and more particularly to an inventory management system utilizing clear to build inventory analysis.

2. Description of the Related Art

As the global economy provides a proliferation of options for businesses to expand into emerging markets, manufacturing success is increasingly defined by how fast you act and how well you react to supply chain volatility. Modern production facilities are increasingly becoming more complex as customers expect manufacturers to keep prices low while readily accommodating last-minute changes in quantity, product configuration or delivery date.

Effectively managing the timing, order policy, and supply and inventory considerations involved in new product introductions or upgrades, greatly impact cycle times, potential business opportunities, and most importantly sales and profits. Typical operations manufacture multiple products in numerous discrete areas called stocking locations within a single facility. Moreover, the parts needed to manufacture a specific product may be utilized and stocked in multiple discrete areas throughout a facility due to their common usage across various sub-assemblies and end products. Component parts may be stocked in warehouses, at sub-assembly lines, in multiple final build lines or in any number of other internal plant locations.

One problem that arises in such complex facilities is whether all the components necessary to build a specific product are available to support the build. After part coverage is determined, a secondary obstacle is determining what stock, from which inventory stocking areas needs to be utilized to complete the build in question. A common method in the art by which inventory is analyzed to determine whether an order can be built is often called “Clear to Build inventory analysis” (CTB).

Essentially, CTB is a process by which the component Bill of Material (BOM) needed to manufacture the product in question is compared against available inventory stocked in a facility. The parts necessary for a product can be stocked in multiple stocking locations. However, conventional CTB analysis can operate upon one defined inventory stocking location at a time, or merely determine the aggregate amount of available parts in a whole facility without reference to specific stocking location allocation information. Additionally, a specific inventory stocking location can either be defined globally or locally.

When global CTB is performed an operation can quickly ascertain if it possesses the total number of parts necessary to support an order in a facility. However, performing global CTB does not efficiently allow determining which parts from which stocking location need to be aggregated to support the build in question. Moreover, as manual actions are taken to decide which parts from the various stocking locations need to be moved and allocated to a specific build, subsequent CTB analysis may be driving other manual activities that will be competing for the same parts.

Local CTB analysis allows determination of the ability to support a specific build with parts from one stocking location within a facility. However, when part shortages are determined in one specific area, additional manual actions are required to search other stocking locations for parts coverage. This could include additional separate CTB analyses in those other areas. Once again, these local CTB analyses often result in numerous manual activities to identify, isolate and move parts from one area to facilitate a build.

Conventional CTB analysis lacks an efficient reservation mechanism. Merely searching each location at a time can cause the possibility that another order may ‘snatch’ a part that was previously contemplated by another order looking in another location. Also, with conventional CTB processes there is a chance that inventory may be ‘locked up’ in multiple orders that can only be partially completed instead of being able to fulfill the highest priority orders that can actually be completed. Yet further, in as much as the parts required for building an order can originate across multiple enterprises, with conventional CTB processes there can be a reliance on cross-enterprise stocked parts within distribution hubs and suppliers. Thus, there are manual activities associated with typical CTB processes and the inherent difficulties in parts logistical management, especially in periods of extreme volatility and stress in a supply chain.

### BRIEF SUMMARY OF THE INVENTION

Embodiments of the present invention address deficiencies of the art in respect to supply chain management and provide a novel and non-obvious method, system and computer program product for an auto-cascading CTB tool for multiple enterprise parts management. In an embodiment of the invention, a method for auto-cascading (CTB) for multiple enterprise parts management can be provided. The method can include receiving a demand resulting in an inventory requirement to satisfy the demand, soft allocating inventory meeting a portion of the inventory requirement from multiple different intra-plant locations in an order of priority specified by a set of inventory location priority rules, further soft allocating inventory meeting a remaining portion of the inventory requirement from inventory of multiple different external suppliers in an order of priority specified by the set of inventory location priority rules, and hard reserving the soft allocated inventory and updating inventory levels both in each of the intra-plant locations and also in the external suppliers.

In one aspect of the embodiment, hard reserving the soft allocated inventory and updating inventory levels both in each of the intra-plant locations and also in the external suppliers can include determining that the inventory requirements have not been met by the soft allocated inventory, and therefore de-allocating the soft allocated inventory in order to allow the re-allocation of the inventory to satisfy a subsequent demand. However, in another aspect of the embodiment, hard reserving the soft allocated inventory and updating inventory levels both in each of the intra-plant locations and also in the external suppliers can include determining that the inventory requirements have not been met by the soft allocated inventory, hard reserving the soft allocated inventory and updating inventory levels both in each of the intra-plant locations and also in the external suppliers, and recording a build short in response to the demand.

In another embodiment of the invention, a multi-enterprise supply chain data processing system configured with an auto-cascading CTB tool for multiple enterprise parts management. The system can include an enterprise resource planning (ERP) computing system executing in a host computing device and managing inventory in multiple different plant locations. The ERP computing system can be communicatively coupled to other ERP computing systems resident in respectively different external supplier hosts for corresponding external suppliers over a computer communications network. The system also can include different inventory location priority rules, each rule setting forth a demand and corresponding priority of the locations and the external suppliers in soft allocating inventory in order to satisfy a given demand in the ERP computing system.

Finally, the system can include multi-enterprise CTB logic. The CTB logic can include program code enabled to receive a demand such as a customer upgrade, an inter-plant request or a new build, each resulting in an inventory requirement to satisfy the demand, to soft allocate inventory meeting a portion of the inventory requirement from the locations in an order of priority specified by the rules, to further soft allocate inventory meeting a remaining portion of the inventory requirement from inventory of the external suppliers in an order of priority specified by the rules, and to hard reserve the soft allocated inventory and to update inventory levels both in each of the locations and also in the external suppliers.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a multi-enterprise supply chain configured with an auto-cascading CTB tool for multiple enterprise parts management;

FIG. 2 is a schematic illustration of a multi-enterprise supply chain data processing system configured with an auto-cascading CTB tool for multiple enterprise parts management;

FIG. 3 is a flow chart illustrating a process for auto-cascading CTB for multiple enterprise parts management.

### DETAILED DESCRIPTION OF THE INVENTION

Embodiments of the present invention provide a method, system and computer program product for a multi-enterprise supply chain configured with an auto-cascading CTB tool for multiple enterprise parts management. In accordance with an embodiment of the present invention, a demand can be made upon an enterprise resource planning system for a plant containing multiple inventory locations. The demand can be analyzed to determine inventory requirements for building to suit the demand. Thereafter, each location for the plant can be inspected in an order set forth by priority rules to soft allocate the required inventory according to an auto-cascading multi-location clear to build process. To the extent that the locations within the plant cannot satisfy the inventory requirements for the demand, any remaining required inventory not already soft allocated within the locations of the plant can be sought amongst coupled external suppliers and hubs (collectively referred to herein as “suppliers”).

In this regard, each external supplier can be inspected in an order of priority specified by the priority rules to soft allocate the remaining required inventory again in an auto-cascading fashion. If the external suppliers can supply the remaining required inventory for the demand, the soft allocated inventory can be hard reserved and the demand can be rendered clear to build. Otherwise, either the demand can be rendered clear to build short, or the soft allocated inventor can be de-allocated for availability to satisfy another demand. In this way, the multi-location clear to build process provided for in the locations of the plant can be extended to external suppliers in a multi-enterprise supply chain.

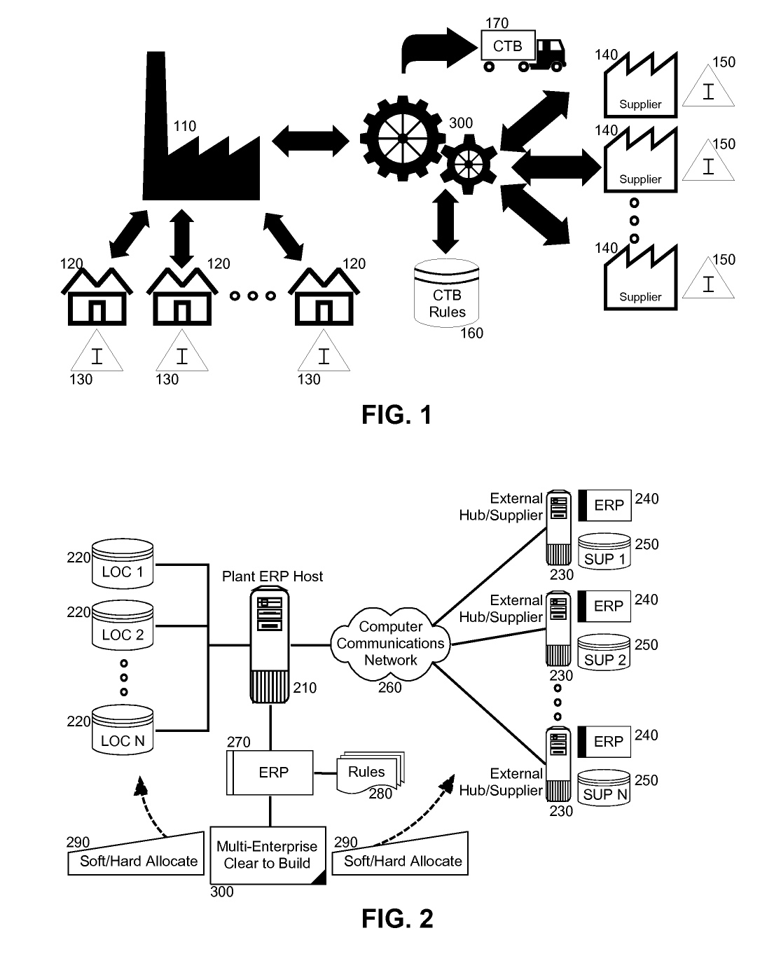

In further illustration, FIG. 1 is a pictorial illustration of a multi-enterprise supply chain configured with an auto-cascading CTB tool for multiple enterprise parts management. As shown in FIG. 1, a plant 110 can include multiple different locations 120 in which inventory 130 is stored and managed. The plant 110 further can rely upon the inventory 150 stored and managed by external suppliers 140. A multi-enterprise clear to build process 300 can be performed in connection with location priority rules 160 in order to determine both in which order the locations 120 are to provide soft allocations of required inventory for a demand, and also in which order the suppliers 140 are to provide soft allocations of required inventory for a demand. To the extent that either or both of the locations 120 and the external suppliers 140 can provide sufficient soft allocations of respective inventory 130, 150 to satisfy a demand, the demand can be rendered clear to build 170 and the soft allocations of the respective inventory 130, 150 can be hard reserved.

The process shown in FIG. 1 can be performed within a multi-enterprise supply chain. In illustration, FIG. 2 schematically depicts a multi-enterprise supply chain data processing system configured with an auto-cascading CTB tool for multiple enterprise parts management. The system can include a plant ERP host computing platform 210 supporting the operation of an ERP computing system 270. The ERP computing system 270 can be coupled to data stores 220 for different physical locations with z the plant and also to location priority rules 280 specifying an order of priority in which inventory is to be allocated from inventory evident reflected as data in each of the data stores 220.

Notably, the plant ERP host 210 can be communicatively coupled to multiple different external suppliers 230 over computer communications network 260. Each of the external suppliers 230 can include an ERP computing system 240 and corresponding data store of supplier inventory 250. In this regard, through the communicative coupling the ERP computing system 270 can be enabled to access inventory data within each data store of supplier inventory 250 and also to issue soft allocate and hard reserve requests 290 for inventory reflected in data stored in the data store of supplier inventory 250.

Importantly, multi-enterprise CTB logic 300 can be coupled to the ERP computing system 270. The multi-enterprise CTB logic 300 can include program code enabled to perform auto-cascading CTB allocation of inventory reflected in the data stores 220 in response to a demand issued upon the ERP computing system 270. Further, program code of the multi-enterprise CTB logic 300 can be enabled to perform auto-cascading CTB allocation of inventory reflected in each data store of supplier inventory 250 in order to satisfy a demand received in the ERP computing system 270 where the inventory reflected by data in the data stores 220 is not sufficient to satisfy the demand alone.

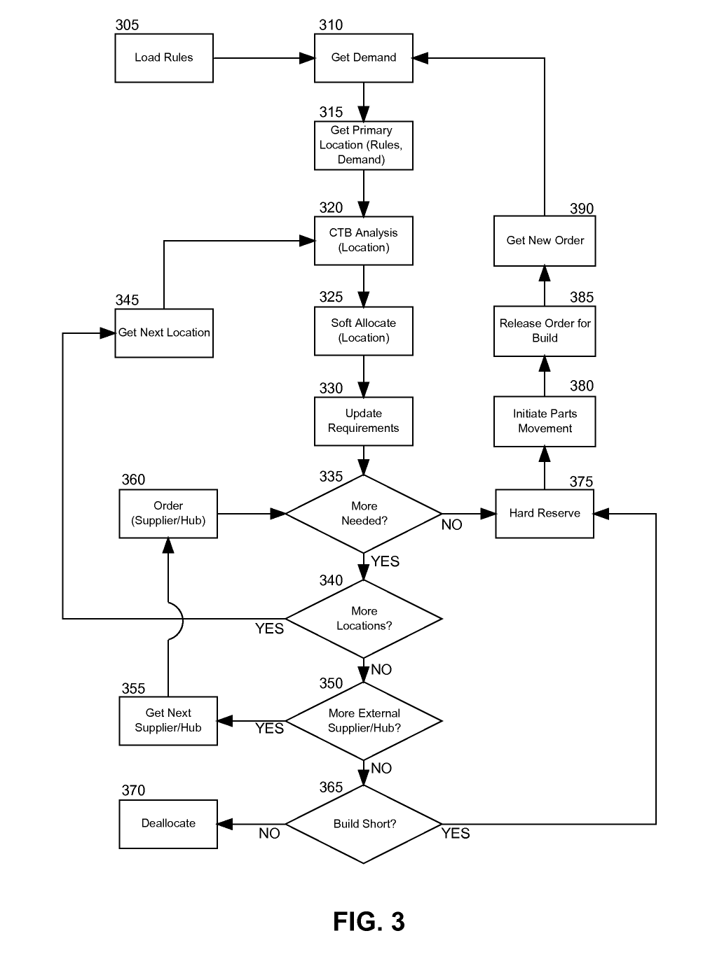

The auto-cascading aspect of the multi-enterprise CTB logic 300 can refer to the ordering of data stores 220, 250 accessed for soft allocations according to a priority specified in the inventory location priority rules 280. The inventory location priority rules 280 can include a table of demand types specifying a corresponding product line, product type, manufacturing phases, and multiple different locations and vendors in order of priority for satisfying required inventory for the demand. In yet further illustration of the operation of the CTB logic 300, FIG. 3 is a flow chart illustrating a process for auto-cascading CTB for multiple enterprise parts management.

Beginning in block 305, the inventory location priority rules can be loaded for both locations in the plant and also for external suppliers. In block 310, a demand can be received in the plant implicating inventory requirements for production. In response, in block 315 a primary location in the plant can be identified according to the rules and the demand. Subsequently, in block 320 a clear to build analysis can be performed for the location—particularly whether required inventory present in the location can be allocated for use in satisfying the demand. As such, in block 325 the available inventor can be soft allocated and in block 330, the required inventory for the demand can be updated to reflect the allocable and now soft allocated inventory in the location.

In decision block 335, it can be determined whether additional inventory is required in order to satisfy the demand. If not, in block 375 the soft allocated inventory in the location can be hard allocated and the demand will have been satisfied. However, if additional inventory is required in order to satisfy the demand, in decision block 340 it can be determined whether or not additional locations remain to be clear to build analyzed. If so, in block 345 a next location specified by the rules can be selected and the process can continue through block 320. However, in decision block 340 if it is determined that no further locations remain to be processed as provided by the rules, a multi-enterprise portion of the process can proceed through decision block 350.

Specifically, in decision block 350 it can be determined whether or not external suppliers have been specified to participate in the auto-cascading clear to build process. If so, in block 355 a highest priority external supplier specified by the rules can be selected and an order for the requisite inventory can be placed consistent with the inventory levels available for the inventory in the external supplier in block 360. Thereafter, in decision block 335 if further inventory remains required to satisfy the demand, again the process can proceed to decision block 350 and a next external supplier can be selected in block 355.

The process can continue until either no further inventory is required to meet the demand in which case the soft allocated inventory can be hard reserved in block 375, or no further external suppliers remain to be considered in decision block 350. Thereafter, in decision block 365 if short building is permitted, the soft allocated inventory can be hard reserved in block 375 even though the inventory falls short of the requisite inventory to meet the demand, or the soft allocated inventory can be de-allocated to allow the soft allocated inventory to be allocated to satisfy a different demand. Subsequently, in block 380 parts movement can be initiated from the various intra-plant locations and external suppliers. Once complete, in block 385 the order can be released for building and in block 390 a new order can be received.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for auto-cascading clear to build (CTB) for multiple enterprise parts management, the method comprising:
receiving a demand resulting in an inventory requirement to satisfy the demand;
soft allocating inventory meeting a portion of the inventory requirement from multiple different intra-plant locations in an order of priority specified by a set of inventory location priority rules;
further soft allocating inventory meeting a remaining portion of the inventory requirement from inventory of multiple different external suppliers in an order of priority specified by the set of inventory location priority rules; and,
hard reserving the soft allocated inventory and updating inventory levels both in each of the intra-plant locations and also in the external suppliers.

2. The method of claim 1, wherein receiving a demand resulting in an inventory requirement to satisfy the demand, comprises receiving a demand selected from the group consisting of a customer upgrade, an inter-plant request and a new build, resulting in an inventory requirement to satisfy the demand.

3. The method of claim 1, wherein hard reserving the soft allocated inventory and updating inventory levels both in each of the intra-plant locations and also in the external suppliers, comprises:
determining that the inventory requirements have not been met by the soft allocated inventory; and,
de-allocating the soft allocated inventory.

4. The method of claim 1, wherein hard reserving the soft allocated inventory and updating inventory levels both in each of the intra-plant locations and also in the external suppliers, comprises:
determining that the inventory requirements have not been met by the soft allocated inventory;
hard reserving the soft allocated inventory and updating inventory levels both in each of the intra-plant locations and also in the external suppliers; and,
recording a build short in response to the demand.

5. The method of claim 1, further comprising:
initiating parts movement from intra-plant and external suppliers responsive to the hard reserving; and,
releasing an order for build following the parts movement.

6. A multi-enterprise supply chain data processing system configured with an auto-cascading clear to build (CTB) tool for multiple enterprise parts management, the system comprising:
an enterprise resource planning (ERP) computing system executing in a host computing device communicatively coupled to a plurality of ERP computing systems resident in respectively different external supplier hosts for corresponding external suppliers over a computer communications network, the ERP computing system managing inventory in multiple different plant locations;
a plurality of inventory location priority rules, each rule setting forth a demand and corresponding priority of the locations and the external suppliers in soft allocating inventory in order to satisfy a given demand in the ERP computing system; and,
multi-enterprise CTB logic comprising program code enabled to receive a demand resulting in an inventory requirement to satisfy the demand, to soft allocate inventory meeting a portion of the inventory requirement from the locations in an order of priority specified by the rules, to further soft allocate inventory meeting a remaining portion of the inventory requirement from inventory of the external suppliers in an order of priority specified by the rules, and to hard reserve the soft allocated inventory and to update inventory levels both in each of the locations and also in the external suppliers.

7. The system of claim 6, wherein the demand is a demand selected from the group consisting of a customer upgrade, an inter-plant request and a new build, resulting in an inventory requirement to satisfy the demand.

8. A computer program product comprising a computer usable medium embodying computer usable program code for auto-cascading clear to build (CTB) for multiple enterprise parts management, the computer program product comprising:
computer usable program code for receiving a demand resulting in an inventory requirement to satisfy the demand;
computer usable program code for soft allocating inventory meeting a portion of the inventory requirement from multiple different intra-plant locations in an order of priority specified by a set of inventory location priority rules;
computer usable program code for further soft allocating inventory meeting a remaining portion of the inventory requirement from inventory of multiple different external suppliers in an order of priority specified by the set of inventory location priority rules; and,
computer usable program code for hard reserving the soft allocated inventory and updating inventory levels both in each of the intra-plant locations and also in the external suppliers.

9. The computer program product of claim 8, wherein the computer usable program code for receiving a demand resulting in an inventory requirement to satisfy the demand, comprises computer usable program code for receiving a demand selected from the group consisting of a customer upgrade, an inter-plant request and a new build, resulting in an inventory requirement to satisfy the demand.

10. The computer program product of claim 8, wherein the computer usable program code for hard reserving the soft allocated inventory and updating inventory levels both in each of the intra-plant locations and also in the external suppliers, comprises:
computer usable program code for determining that the inventory requirements have not been met by the soft allocated inventory; and,
computer usable program code for de-allocating the soft allocated inventory.

11. The method of claim 8, wherein the computer usable program code for hard reserving the soft allocated inventory and updating inventory levels both in each of the intra-plant locations and also in the external suppliers, comprises:
computer usable program code for determining that the inventory requirements have not been met by the soft allocated inventory;
computer usable program code for hard reserving the soft allocated inventory and updating inventory levels both in each of the intra-plant locations and also in the external suppliers; and,
computer usable program code for recording a build short in response to the demand.

12. The computer program product of claim 8, further comprising:
computer usable program code for initiating parts movement from intra-plant and external suppliers responsive to the hard reserving; and,
computer usable program code for releasing an order for build following the parts movement.
